(19) United States
(12) Patent Application Publication
(10) Pub. No.: US 2018/0023010 A1
(43) Pub. Date: Jan. 25, 2018

(54) METHOD FOR SOFTENING SULFIDE-TYPE COMPOUNDS OF AN OLEFINIC GASOLINE

(71) Applicant: IFP Energies nouvelles, Rueil-Malmaison Cedex (FR)

(72) Inventors: Philibert LEFLAIVE, Mions (FR); Clementina GARCIA-LOPEZ, Irigny (FR); Julien GORNAY, Les Cotes D Arey (FR); Annick PUCCI, Croissy Sur Seine (FR); Diamantis ASTERIS, Chatou (FR); Marie GODARD-PITHON, Rueil-Malmaison (FR)

(73) Assignee: IFP Energies nouvelles, Rueil-Malmaison Cedex (FR)

(21) Appl. No.: 15/537,793

(22) PCT Filed: Dec. 4, 2015
(86) PCT No.: PCT/EP2015/077767

§ 371 Date: Jun. 19, 2017

(30) Foreign Application Priority Data
Dec. 18, 2014 (FR) 14/62798

(51) Int. Cl. C10G 65/06; B01J 35/10; B01J 23/883

(52) U.S. Cl. CPC C10G 65/06; B01J 23/883; B01J 35/1019; C10G 2300/104; C10G 2300/1044; C10G 2300/202; C10G 2400/02; C10G 2300/4087

(57) ABSTRACT

This invention relates to a method for reducing the content of sulfide-type compounds of formula R1-S—R2, with R1 and R2 selected from among the methyl (CH₃) and ethyl (C₂H₅) radicals, of a gasoline that contains diolefins, monoolefins, and sulfur. The method implements a first catalytic step for selective hydrogenation of diolefins at a temperature of between 60° C. and 150° C. and then a step for heating the effluent that is obtained from the first step with a temperature difference ΔT of between 10° C. and 100° C. and a second catalytic step on the effluent that is heated in such a way as to produce an effluent that has a content of sulfide-type compounds of formula R1-S—R2, with R1 and R2 selected from among the methyl (CH3) and ethyl (C2H5) radicals, lower than that of the starting gasoline.

This invention relates to a method for reducing the content of sulfide-type compounds of formula R1-S—R2 with R1 and R2 selected from among the methyl and the ethyl of a gasoline.

The method according to the invention can be integrated as a pretreatment step in a method for hydrodesulfurization of a gasoline so as to limit the content of light sulfur-containing compounds of the sulfide type.

### STATE OF THE ART

The production of gasolines that meet the new environmental standards requires that their sulfur content be significantly reduced to values that in general do not exceed 50 ppm, and preferably less than 10 ppm.

It is known, furthermore, that the conversion gasolines, and more particularly those that originate from catalytic cracking, which can represent 30 to 50% of the gasoline pool, have high contents of olefins and sulfur.

The sulfur that is present in the gasolines for this reason can be nearly 90% attributed to the gasolines that are obtained from catalytic cracking methods, which will be called FCC (fluid catalytic cracking in the English terminology, which can be translated by catalytic cracking in a fluidized bed) gasoline below. The FCC gasolines therefore constitute the preferred feedstock of the method of this invention.

Among the possible methods for producing fuels with a low sulfur content, the one that has been very widely adopted consists in treating specifically the sulfur-rich gasoline bases by hydrodesulfurization methods in the presence of hydrogen and a catalyst. The traditional methods desulfurize the gasolines in a non-selective manner by hydrogenating a large portion of the monoolefins, which results in a high loss in octane number and a heavy consumption of hydrogen. The most recent methods, such as the Prime G+ method (commercial trademark), make it possible to desulfurize the olefin-rich cracking gasolines, while limiting the hydrogenation of monoolefins and consequently the octane loss and the heavy consumption of hydrogen that results therefrom. Such methods are described in, for example, the patent applications EP 1077247 and EP 1174485.

As described in the patent applications EP 1077247 and EP 1 800 748, it is advantageous to carry out, before the hydrotreatment step, a step for selective hydrogenation of the feedstock that is to be treated. This first hydrogenation step essentially consists in hydrogenating the diolefins selectively, while jointly transforming the saturated light sulfur-containing compounds by increasing the weight (by increasing their molecular weight), which compounds are sulfur-containing compounds whose boiling points are lower than that of thiophene, such as methanethiol, ethanethiol, propanethiol, and dimethyl sulfide. By fractionating the gasoline that is obtained from the selective hydrogenation step, a light desulfurized gasoline fraction (or LCN for Light Cracked Naphtha in the English terminology) is produced, which fraction consists for the most part of monoolefins with 5 or 6 carbon atoms without loss of octane, which can be upgraded to the gasoline pool for the formulation of fuel for vehicles.

Under specific operating conditions, this hydrogenation selectively carries out the hydrogenation of diolefins that are present in the feedstock that is to be treated into monolefinic compounds, which have a better octane number. Another effect of the selective hydrogenation is to prevent the gradual deactivation of the selective hydrodesulfurizing catalyst and/or to prevent a gradual clogging of the reactor due to the formation of polymerization gums on the surface of the catalysts or in the reactor. Actually, the polyunsaturated compounds are unstable and have a tendency to form gums by polymerization.

The patent application EP 2161076 discloses a method for selective hydrogenation of polyunsaturated compounds, and more particularly diolefins, making it possible to carry out jointly the increasing in weight of saturated light sulfur-containing compounds. This method uses a catalyst that contains at least one metal of group VIb and at least one non-noble metal of group VIII that are deposited on a porous substrate.

It was noted that when the content of light sulfide compounds, i.e., of formula R1-S—R2 with R1 and R2 selected from among methyl and ethyl, was significant, the selective hydrogenation step was not effective enough to convert these compounds in such a way that after fractionation, a light gasoline fraction LCN containing a significant quantity of light sulfide compounds is obtained. To respond to this problem, it is completely conceivable to toughen the temperature conditions of the selective hydrogenation step but this at the cost of a premature deactivation of the catalyst and a quick fouling of the internals of the reactor, with these phenomena being linked to the formation of coke by polymerization of diolefins contained in the gasoline that is to be treated. Another solution would consist in reducing the hourly volumetric flow rate of the gasoline that is to be treated in the reactor but that would require using more catalyst and increasing the height of the reactor; this solution is not necessarily desirable from the economic and/or technical standpoint.

One object of the invention is therefore to propose a method that is of enhanced effectiveness for reducing the content of light-sulfide-type compounds of a gasoline (or a mixture of gasolines) and that can be implemented during elongated cycle times before the replacement of the catalyst and/or the cleaning of the facility in which the method is carried out.

### SUMMARY OF THE INVENTION

The invention thus relates to a method for reducing the content of sulfide-type compounds of formula R1-S—R2, with R1 and R2 selected from among the methyl (CH₃) and ethyl (C₂H₅) radicals, of a gasoline that contains diolefins, monoolefins, and sulfur, in which:
A) In a first reactor, the gasoline is brought into contact with hydrogen and a catalyst A that comprises at least one metal of group VIb and at least one non-noble metal of group VIII that are deposited on a substrate, with step A being carried out at a temperature in the reactor of between 60° C. and 150° C. with an hourly volumetric flow rate (VVH) of between 1 h⁻¹ and 10 h⁻¹, a pressure of between 0.5 and 5 MPa, and with a volumetric ratio of added H₂/gasoline feedstock of between 1 to 40 normal liters of hydrogen per liter of gasoline (vol/vol), in such a way as to produce an effluent at a temperature T1 of between 60° C. and 150° C. and having a lower diolefin content than that of the starting gasoline;
B) The effluent that is obtained from the first reactor is heated in a heating device at a temperature T2 with a temperature difference ΔT (T2-T1) of between 10° C. and 100° C.;
C) In a second reactor, the effluent that is heated at the temperature T2 is brought into contact with a catalyst C that comprises at least one metal of group VIb and at least one non-noble metal of group VIII that are deposited on a substrate and optionally with hydrogen, and in which: Step C is carried out with an hourly volumetric flow rate (VVH) of between 1 h⁻¹ and 10 h⁻¹, a pressure of between 0.5 and 5 MPa, with a volumetric ratio of added H₂/gasoline feedstock of between 0 to 40 normal liters of hydrogen per liter of gasoline (vol/vol), in such a way as to produce an effluent from the second reactor that has a content of sulfide-type compounds of formula R1-S—R2, with R1 and R2 selected from among the methyl (CH3) and ethyl (C2H5) radicals, lower than that of the starting gasoline.

The applicant observed, surprisingly enough, that a method that implements two successive steps of catalytic hydrogenation in the presence of catalysts and under the conditions described above makes it possible not only to promote the conversion of the light-sulfide-type compounds by preserving the octane number of the gasoline as much as possible, while limiting the deactivation of the catalyst and the fouling of the reactors by the formation of coke deposits respectively on the catalyst and on the internals of the reactor. Within the context of the invention, the term “reduce the content of light-sulfide-type compounds” refers to the fact that the content of light-sulfide-type compounds that is present in the reaction effluent that is obtained after the second step is smaller than that of the gasoline that is treated.

According to a preferred embodiment, the temperature difference ΔT (T2-T1) is between 20° C. and 80° C. Preferably, the temperature difference ΔT (T2-T1) is between 30° C. and 80° C.

The method according to the invention can also comprise a step D in which the effluent that is obtained from step C is separated into a light gasoline fraction with a low sulfur content and a heavy gasoline fraction that contains hydrocarbons having six and more than six carbon atoms. For example, the total sulfur content of said light gasoline fraction is less than 15 ppm by weight, and even less than 10 ppm by weight, and the content of light sulfides is less than 10 ppm by weight of sulfur.

In one embodiment, steps C and D are carried out in a catalytic distillation column that comprises a catalytic cross-section that contains the catalyst C.

Preferably, the thus recovered heavy gasoline fraction is treated in a hydrodesulfurization unit in the presence of hydrogen.

The catalysts A and C are preferably sulfurized. Preferably, the sulfurization rate of the metals that constitute said catalysts is at least equal to 60%.

Preferably, the catalyst A and/or the catalyst C comprise:
An oxide content of the metal of group VIb of between 4 and 20% by weight in relation to the total weight of the catalyst,
An oxide content of the metal of group VIII of between 4 to 15% by weight in relation to the total weight of the catalyst,
A sulfurization rate of the metals that constitute said catalyst that is at least equal to 60%,
A molar ratio between the non-noble metal of group VIII and the metal of group VIb of between 0.6 and 3 mol/mol,
A density of metal of group VIb per unit of surface area of the catalyst that is strictly less than 10⁻³ gram of oxides of the metal of group VIb per m² of catalyst,
A specific surface area of the catalyst of between 30 and 300 m²/g.

Preferably, the metal of group VIb of the catalysts A and C is selected from among molybdenum and tungsten, preferably molybdenum.

Preferably, the metal of group VIII of the catalysts A and C is selected from among nickel, cobalt, and iron, preferably nickel.

In a preferred embodiment, the metal of group VIII of the catalysts A and C is nickel, and the metal of group VIb of the catalysts A and C is molybdenum.

According to a preferred embodiment, the catalysts A and C are identical compositions.

The method according to the invention is particularly suitable for treating a gasoline that is obtained from catalytic cracking or thermal cracking, a coking method, a visbreaking method, or a pyrolysis method.

### DETAILED DESCRIPTION OF THE INVENTION

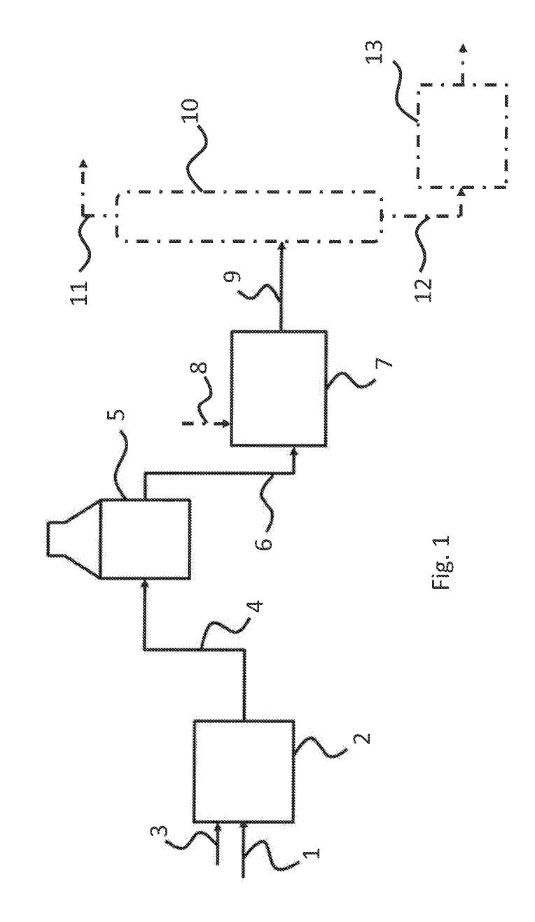

The other characteristics and advantages of the invention will emerge from reading the following description, provided on a uniquely illustrative and non-limiting basis, and with reference to FIG. 1, which is a schematic diagram of the method according to the invention.

The hydrocarbon feedstock that can be treated by the method according to the invention is an olefinic-type gasoline that contains diolefins, monoolefins, and sulfur-containing compounds in the form of in particular mercaptans and light sulfides. Within the scope of the invention, the term “light-sulfide-type compounds” refers to compounds of formula R1-S—R2 where R1 and R2 are selected from among the methyl (CH₃) and ethyl (C₂H₅) radicals. Thus, the lightest sulfide that is present in the olefinic gasoline is dimethyl sulfide.

This invention finds its application for treating gasolines that are obtained from conversion methods and in particular gasolines (by themselves or in a mixture) originating from catalytic cracking or thermal cracking, a coking method, a visbreaking method, or a pyrolysis method.

The hydrocarbon feedstocks for which the invention applies have a boiling point that is in general between 0° C. and 280° C., preferably between 15° C. and 250° C., and they can also contain hydrocarbons with 3 or 4 carbon atoms.

The gasoline that is treated by the method according to the invention in general contains between 0.5% and 5% by weight of diolefins, between 20% and 55% by weight of monoolefins, between 10 ppm and 1% by weight of sulfur, and in which the content of light sulfide compounds of formula R1-S—R2, where R1 and R2 are selected from among the methyl (CH₃) and ethyl (C₂H₅) radicals, is in general between 1 and 150 ppm by weight of sulfur.

Preferably, the gasoline that can be treated is obtained from a fluidized-bed catalytic cracking unit (Fluid Catalytic Cracking in the English terminology). A mixture of gasolines originating from a fluidized-bed catalytic cracking unit with one or more gasolines obtained from another conversion method can also be treated.

With reference to FIG. 1, the gasoline feedstock is treated in a first catalytic step. Thus, the gasoline is sent via the line 1 into a first reactor 2 and in which it is brought into contact with hydrogen (provided by line 3) and a selective hydrogenation catalyst A. The reactor 2 can be a reactor with a fixed or moving catalytic bed, preferably fixed. The reactor can comprise one or more catalytic beds.

In the reactor 2, the gasoline that is to be treated is mixed with hydrogen and brought into contact with the catalyst A. The quantity of injected hydrogen is such that the volumetric ratio of added H₂/gasoline feedstock is between 1 to 40 normal liters of hydrogen per liter of gasoline (vol/vol) and preferably between 1 and 5 normal liters of hydrogen per liter of gasoline (vol/vol). Too large an excess of hydrogen can bring about a strong hydrogenation of the monoolefins and consequently a reduction of the octane number of the gasoline. The entire feedstock is in general injected at the inlet of the reactor. However, it may be advantageous, in some cases, to inject a portion or all of the feedstock between two consecutive catalytic beds that are placed in the reactor. This embodiment makes it possible in particular to continue to operate the reactor if the inlet of the reactor or the first catalytic bed are clogged by deposits of polymers, particles, or gums that are present in the feedstock.

The mixture that consists of gasoline and hydrogen is brought into contact with the catalyst A at a temperature of between 60° C. and 150° C. and preferably between 80 and 130° C., with an hourly volumetric flow rate (VVH or liquid hourly space velocity LHSV in the English terminology) of between 1 h⁻¹ and 10 h⁻¹, with the unit of the hourly volumetric flow rate being one liter of feedstock per hour per liter of catalyst (L/h/L, or h⁻¹). The pressure is adjusted so that the reaction mixture is for the most part in liquid form in the reactor. The pressure is between 0.5 MPa and 5 MPa and preferably between 1 and 4 MPa.

As indicated in FIG. 1, a reaction effluent is drawn off from the reactor 2 via the line 4. This effluent has a smaller diolefin content in relation to the gasoline that is to be treated because of the selective hydrogenation reaction that it has undergone. The effluent that is obtained from the hydrogenation reactor 2 has a temperature T1 that is close to the mean temperature of the reactor 2 and in general higher (typically by 1 to 3° C.) than that of the feedstock at the inlet of the reactor 2, since the reaction for selective hydrogenation of the diolefins is exothermic.

According to the invention, the effluent that is obtained from the reactor 2 is heated to a temperature T2 in a heating device 5 that can be, for example, a heat exchanger or a furnace as indicated in FIG. 1. The effluent is heated in such a way that the temperature difference ΔT (T2-T1) is between 10° C. and 100° C., preferably between 20° C. and 80° C., and in a more preferred manner between 30° C. and 60° C.

The effluent that is heated at the temperature T2 is then transferred via the line 6 into a second reactor 7 that comprises a (fixed or moving) bed of catalyst C where it is subjected to a second catalytic step. As indicated in FIG. 1, the reactor 7 can be supplied with hydrogen via the line 8 that is optional. The heated effluent is brought into contact with a catalyst C and optionally added hydrogen so as to convert the compounds of the light sulfide type. The catalysts C and A can be identical or different; preferably, they are identical. According to the invention, this second catalytic step is carried out under operating conditions that are more rigorous in terms of temperature.

Thus, this second step is carried out under the following operating conditions:
At a temperature that is higher than that of the first step for selective hydrogenation of diolefins,
With an hourly volumetric flow rate (VVH) of between 1 h⁻¹ and 10 h⁻¹,
At a pressure of between 0.5 and 5 MPa, and
With a volumetric ratio of added H₂/gasoline feedstock of between 0 and 40 normal liters of hydrogen per liter of gasoline.

The second step is therefore performed under conditions of a temperature that is higher than the temperature of the first catalytic step and with a temperature difference of the second step in relation to the temperature of the first step that is in general between 10° C. and 100° C., preferably between 20° C. and 80° C., and in a more preferred manner between 30° C. and 60° C.

It should be noted that this second step is different from a catalytic hydrodesulfurization (or HDS) step in which the sulfur-containing compounds are converted into H₂S and into hydrocarbons by contact with a catalyst that has hydrogenolyzing properties. The hydrodesulfurization is in general performed at a temperature of between 200 and 400° C., with a volumetric ratio of added H₂/gasoline feedstock of between 100 to 600 normal liters of hydrogen per liter of gasoline (vol/vol), at a total pressure of between 1 MPa and 3 MPa, and with an hourly volumetric flow rate (VVH) of between 1 h⁻¹ and 10 h⁻¹.

The catalysts A and C that are used in the method according to the invention comprise at least one metal of group VIb (group 6 according to the new notation of the periodic table: Handbook of Chemistry and Physics, 76^{th} Edition, 1995-1996) and at least one non-noble metal of group VIII (groups 8, 9, and 10 according to the new notation of the periodic table: Handbook of Chemistry and Physics, 76^{th} Edition, 1995-1996) deposited on a substrate.

Preferably, the catalysts A and C are used in sulfurized form. In a preferred manner, the sulfurization rate of the catalysts is at least 60%.

The sulfurization of the catalysts can be done in a sulforeducing medium, i.e., in the presence of H₂S and hydrogen, so as to transform the metal oxides into sulfides, such as, for example, MoS₂ and Ni₃S₂. The sulfurization is carried out, for example, by injecting into the catalyst a stream that contains H₂S and hydrogen, or else a sulfur-containing compound that can decompose into H₂S in the presence of the catalyst and hydrogen. The polysulfides such as dimethyl disulfide are H₂S precursors that are commonly used for sulfurizing the catalysts. The temperature is adjusted so that H₂S reacts with the metal oxides to form metal sulfides. This sulfurization can be carried out in situ or ex situ (inside or outside) of the reactor of the first and second steps at temperatures of between 200 and 600° C. and more preferably between 300 and 500° C.

An element is considered to be substantially sulfurized when the molar ratio between the sulfur (S) that is present in the catalyst and said element is preferably at least equal to 60% of the theoretical molar ratio that corresponds to the total sulfurization of the element that is being considered:

(S/element)_{catalyst}≧0.6×(S/element)_{theoretical}

with:

(S/element)_{catalyst}=molar ratio between the sulfur (S) and the element that are present in the catalyst

(S/element)_{theoretical}=molar ratio between sulfur and the element corresponding to the total sulfurization of the sulfide element.

This theoretical molar ratio varies according to the element that is being considered:

(S/Fe)_{theoretical}=1

(S/Co)_{theoretical}=8/9

(S/Ni)_{theoretical}=2/3

(S/Mo)_{theoretical}=2/1

(S/W)_{theoretical}=2/1

When the catalyst comprises several metals, the molar ratio between the S that is present in the catalyst and all of the elements is preferably at least equal to 60% of the theoretical molar ratio that corresponds to the total sulfurization of each sulfide element, with the calculation being performed in proportion to the relative molar fractions of each element.

For example, for a catalyst that comprises molybdenum and nickel with a respective molar fraction of 0.7 and 0.3, the minimum molar ratio (S/Mo+Ni) is provided by the equation:

(S/Mo+Ni)_{catalyst}=0.6×{(0.7×2)+(0.3×(2/3)}

In a very preferred way, the sulfurization rate of the metals will be more than 80%.

Preferably, the sulfurization is implemented on the metals in oxide form without a preliminary step for reducing metals being carried out. Actually, it is known that the sulfurization of reduced metals is more difficult than the sulfurization of metals in oxide form.

The catalysts A and C according to the invention can have the following characteristics:
A metal oxide content of group VIb is between 4 and 20% by weight in relation to the total weight of the catalyst,
A metal oxide content of group VIII is between 4 to 15% by weight in relation to the total weight of the catalyst,
A sulfurization rate of the metals that constitute said catalyst is at least equal to 60%,
A molar ratio between the non-noble metal of group VIII and the metal of group VIb is between 0.6 and 3 mol/mol,
A specific surface area of the catalyst is between 30 and 300 m²/g.

Preferably, the catalysts A and C have a metal density of group VIb per unit of surface area of catalyst that is strictly less than 10⁻³ gram of oxides of the metal of group VIb per m² of catalyst.

The catalysts A and C preferably have a content by weight of the element of group VIb in oxide form of between 6 and 18%, preferably between 8 and 12%, and in an even more preferred manner of between 10 and 12% by weight in relation to the weight of the catalyst. The metal of group VIb is preferably selected from among molybdenum and tungsten. In a more preferred manner, the metal of group VIb is molybdenum.

The catalysts A and C also contain a metal of group VIII that is preferably selected from among nickel, cobalt, and iron. In a more preferred manner, the metal of group VIII is nickel. The metal content of group VIII expressed in oxide form is between 4 and 12% by weight and preferably between 6 and 10% by weight and in an also preferred manner between 6 and 8% by weight in relation to the weight of the catalyst.

The molar ratio between the non-noble metal of group VIII and the metal of group VIb is between 0.6 and 3 mol/mol and in a preferred manner between 1 and 2 mol/mol.

The density of metal of group VIb, expressed as the ratio between said content by weight of oxide of the metal of group VIb and the specific surface area of the catalyst, is between 10⁻⁴ and 10⁻³ g/m², preferably between 4 and 6.10⁻⁴ g/m², and in a more preferred manner between 4.3 and 5.5.10⁻⁴ g/m². Thus, for example, in the case depicted where the catalyst comprises 11% by weight of molybdenum oxide in relation to the weight of catalyst and has a specific surface area of 219 m²/g, then the density of molybdenum, expressed as the ratio between the content by weight of molybdenum oxide (MoO₃) and the specific surface area of the catalyst, is equal to (0.11/219) or 5.10⁻⁴ g/m².

The specific surface area of the catalysts A and C is preferably between 100 and 300 m²/g and in a more preferred manner between 150 and 250 m²/g. The specific surface area is determined according to the standard ASTM D3663.

Preferably, the catalysts A and C have a total pore volume that is measured by mercury porosimetry that is greater than 0.3 cm³/g, preferably between 0.4 and 1.4 cm³/g and preferably between 0.5 and 1.3 cm³/g. The mercury porosimetry is measured according to the standard ASTM D4284-92 with a wetting angle of 140°, with a model apparatus Autopore III of the trademark Microméritics.

The substrate of catalysts A and C is preferably selected from among alumina, nickel aluminate, silica, silicon carbide, or a mixture thereof. In a preferred manner, alumina is used.

According to a variant, the substrate of catalysts A and C consists of cubic gamma-alumina or delta-alumina.

According to a particularly preferred variant, the catalysts A and/or C are NiMo alumina catalysts.

The catalysts A and C according to the invention can be prepared by means of any technique that is known to one skilled in the art and in particular by impregnation of elements of groups VIII and VIb on the selected substrate. This impregnation can be carried out, for example, according to the method known to one skilled in the art under the terminology of dry impregnation, in which the exact quantity of elements desired in the form of soluble salts is introduced into the selected solvent, for example demineralized water, in such a way as to fill as exactly as possible the porosity of the substrate.

After the introduction of metals of groups VIII and VIb, and optionally a shaping of the catalyst, the former undergoes an activation treatment. The object of this treatment in general is to transform the molecular precursors of the elements into the oxide phase. In this case, it is a matter of an oxidizing treatment, but a simple drying of the catalyst can also be performed. In the case of an oxidizing treatment, also called a calcination, the former is generally implemented in air or in dilute oxygen, and the treatment temperature is in general between 200° C. and 550° C., preferably between 300° C. and 500° C.

After calcination, the metals that are deposited on the substrate are in oxide form. In the case of nickel and molybdenum, the metals are primarily in the form of MoO₃ and NiO. Preferably, the catalysts A and C are used in their sulfurized form, i.e., they have undergone a sulfurization activation step after the oxidizing treatment.

According to an embodiment, the catalysts A and C that are used respectively in the reactors 2 and 7 are identical compositions.

Advantageously, the effluent that is obtained from the second catalytic step is sent via the line 9 into a fractionation column so as to provide at least one light gasoline fraction 11 (or LCN for Light Cracked Naphtha in the English terminology), which is drawn off at the top of the column 10, and a heavy gasoline fraction 12 (HCN for Heavy Cracked Naphtha in the English terminology), which is recovered at the bottom of the column 10.

The fraction point of the fractionation column is selected in such a way that the light gasoline fraction has a substantial quantity of olefins that have less than six carbon atoms (“C6”) and a low content of light-sulfide-type compounds and the heavy gasoline fraction has a large quantity of sulfur-containing compounds such as the mercaptans, with the compounds of the thiophene family and the sulfides and olefins having 6 or more carbon atoms (“C6+”). The fraction point is regulated in such a way that the light gasoline fraction has a boiling point of between −5° C. and 70° C., preferably between −5° C. and 65° C. As for the heavy gasoline fraction, it may have a boiling point of between 60° C. and 280° C., preferably between 65° C. and 280° C. The skilled person in the art knows that the separations of hydrocarbons are imperfect and, consequently, a certain overlapping in the boiling points of the light and heavy fractions can be produced near the fraction point. Typically, the light gasoline fraction has a total sulfur content of less than 15 ppm, preferably less than 10 ppm by weight, and a light sulfide content that is less than 10 ppm by weight of sulfur.

The light gasoline fraction that is thus produced by the fractionation, which is rich in olefins (therefore with a high octane number) and low in sulfur-containing compounds, including light sulfides, is advantageously sent, after elimination of hydrogen and stabilization, to the gasoline pool for the formulation of gasoline-type fuel. This fraction in general does not require additional hydrodesulfurization treatment.

The heavy gasoline fraction that contains the majority of the organo-sulfur-containing compounds including the sulfides is advantageously treated in a hydrodesulfurization (HDS) unit that comprises a reactor 13 that is equipped with a catalyst bed that has hydrogenolyzing properties. The HDS catalyst can comprise at least one metal of group VIb, for example molybdenum, and at least one metal of group VIII, for example cobalt, deposited on a substrate. It will be possible to refer in particular to the documents EP 1 369 466 and EP 1 892 039 of the applicant that describe the HDS catalysts.

The operating conditions that make possible a hydrodesulfurization of the heavy gasoline fraction are:
A temperature of between approximately 200 and approximately 400° C., preferably between 250 and 350° C.;
A total pressure of between 1 MPa and 3 MPa, preferably between 1 MPa and approximately 2.5 MPa;
A volumetric ratio of added H₂/gasoline feedstock of between 100 to 600 normal liters of hydrogen per liter of gasoline (vol/vol); and
An hourly volumetric flow rate (VVH) of between 1 h⁻¹ and 10 h⁻¹, preferably between 2 h⁻¹ and 8 h⁻¹.

The desulfurized heavy gasoline fraction, after elimination of the H₂S that is formed and after stabilization, can then be sent to the gasoline pool and/or to the diesel pool based on the requirements of the refiner.

According to an alternative embodiment, steps C and D for separation of the gasoline into two light and heavy fractions are performed concomitantly by using a reactive distillation column. The reactive distillation column is a distillation column that comprises a reaction zone that is equipped with at least one catalytic bed. The catalytic column is configured and operated in such a way as to fractionate the gasoline feedstock that is treated in the reactor 2 into two fractions, namely a heavy fraction and a light fraction. Furthermore, the catalytic bed is placed in the upper part of said column in such a way that the light fraction encounters the catalytic bed during the fractionation.

The method according to the invention can thus be integrated into a hydrodesulfurization unit as a step for pretreatment of the gasoline before the hydrodesulfurization step itself.

### EXAMPLES

### Example 1

Table 1 exhibits the general characteristics of a gasoline that has been treated according to the invention. The MAV is the maleic anhydride index (Maleic Anhydride Value in the English terminology) and provides an indication of the content of conjugated diolefins (gum precursor compounds) in the gasolines.

TABLE 1
Characteristics of the Gasoline

| Composition of the | | |
|---|---|---|
| Gasoline | Unit | Value |
| Density at 15° C. | g/cm³ | 0.697 |
| MAV | g/100 g | 12 |
| Content of Elementary | % m/m | 0.204 |
| Sulfur | | |
| Content of Light Sulfides | | |
| Dimethyl Sulfide | ppm of S | 39 |
| Methyl Ethyl Sulfide | ppm of S | 54 |
| Content of Olefins | % m/m | 46.8 |
| Simulated Distillation | | |
| Initial Point | ° C. | −4 |
| Final Point | ° C. | 208 |
| RON of the Gasoline | — | 88.9 |
| MON of the Gasoline | — | 76.4 |

The gasoline is treated in the presence of a catalyst A in a single reactor.

The catalyst A is a catalyst of NiMo gamma-alumina type. The contents of metals are respectively 7% by weight of NiO and 11% by weight of MoO₃ in relation to the total weight of the catalyst, or an Ni/Mo molar ratio of 1.2. The specific surface area of the catalyst is 230 m²/g. Prior to its use, the catalyst A is sulfurized at atmospheric pressure of a sulfurization bank under an H₂S/H₂ mixture that consists of 15% by volume of H2S with 1 L/g·h of catalyst and at 400° C. for two hours. This operating procedure makes it possible to obtain a sulfurization rate of higher than 80%.

Table 2 groups the operating conditions used as well as the results of conversion of the light sulfides.

TABLE 2

| | | Added | | | Residual | Dimethyl Sulfide | | Methyl Ethyl Sulfide | |
|---|---|---|---|---|---|---|---|---|---|
| | VVH | H₂/HC | Temperature | Pressure | MAV | Content | Conversion | Content | Conversion |
| Example | h⁻¹ | NL/L | ° C. | MPa | mg/100 g | ppm of S | % | ppm of S | % |
| 1 | 1.5 | 5 | 130 | 2.5 | 3.6 | 28 | 29% | 42 | 23% |

It is noted that the light sulfides are only very sparingly converted at the temperature of 130° C. By contrast, it will be noted that the quantity of diolefins is reduced by the selective hydrogenation reaction.

### Example 2

The same gasoline (see Table 1) is treated with the same catalyst A as Example 1 but under more rigorous temperature conditions (T=180° C.), with the other operating conditions not having been modified. Table 3 provides the conditions for treatment of the gasoline with the catalyst A in a single reactor at the temperature of 180° C.

TABLE 3

| | | | | | | Dimethyl Sulfide | | Methyl Ethyl Sulfide | |
|---|---|---|---|---|---|---|---|---|---|
| | | Added | | | Residual | Residual | | Residual | |
| | VVH | H₂/HC | Temperature | Pressure | MAV | Content | Conversion | Content | Conversion |
| Example | h⁻¹ | NL/L | ° C. | MPa | mg/100 g | ppm of S | % | ppm of S | % |
| 2 | 1.5 | 5 | 180 | 2.5 | <0.5 | 2 | 95% | 5.5 | 90% |

It is noted that the conversion of the light sulfides increases (90 to 95% of conversion). Thus, the fact of treating the feedstock at more rigorous temperature conditions (180° C.) makes it possible to increase the conversion of the light sulfides but at the risk of reducing the life cycle of the catalyst because of the formation of coke on its surface. As indicated in Table 4, the level of coke that is formed after 1 month of operation increases with the temperature of use of the catalyst.

TABLE 4

| | | Added | | | | Residual |
|---|---|---|---|---|---|---|
| | VVH | H₂/HC | Temperature | Pressure | | Coke |
| Example | h⁻¹ | NL/L | ° C. | MPa | Reactor | % |
| 1 | 1.5 | 5 | 130 | 2.5 | 1 | 2.8 |
| 2 | 1.5 | 5 | 180 | 2.5 | 1 | 3.6 |

### Example 3 (According to the Invention)

According to the invention that is proposed, the gasoline that is described in Table 1 is treated in 2 steps. The first step, using a first reactor R1 that is charged with the catalyst A, is operated at a temperature of 130° C. so as to reduce the content of diolefins (MAV) that are precursor compounds of gums and coke. The gasoline from the reactor R1 is heated at 187° C. (or a ΔT=57° C.) with a heating device before being introduced into a second reactor R2. The reactors R1 and R2 are operated in isothermal mode. The second reactor R2 is charged with a catalyst C that has the same composition as the catalyst A.

It is further specified that the hourly volumetric flow rates (VVH) in the reactors R1 and R2 have been set at 3 h⁻¹ so as to preserve a total quantity of catalyst that is equivalent to the preceding cases.

Table 5 groups the operating conditions used in the reactors R1 and R2 as well as the analysis of light sulfides of the gasoline that is drawn off from the reactor R2.

TABLE 5

| | | | | | | Dimethyl Sulfide | | Methyl Ethyl Sulfide | |
|---|---|---|---|---|---|---|---|---|---|
| | | Added | | | Residual | Residual | | Residual | |
| | VVH | H₂/HC | Temperature | Pressure | MAV | Content | Conversion | Content | Conversion |
| Reactor | h⁻¹ | NL/L | ° C. | MPa | mg/g | ppm of S | % | ppm of S | % |
| R1 | 3 | 5 | 130 | 2.5 | — | — | — | — | — |
| R2 | 3 | 5 | 180 | 2.5 | <0.5 | 1.5 | 96% | 6 | 89% |

The effluent from the 2^{nd} reactor R2 has a MAV index that is less than 0.5 mg/g (low measuring limit) and also reduced light sulfide content. The dimethyl sulfide and the methyl ethyl sulfide are converted to 96% and 89% respectively.

It is noted based on Table 6 that the service life of the catalyst of the reactor R2 is increased because the level of deposited coke, which can deactivate the catalyst, after 1 month of operation, is lower than the level of coke found in the catalyst of Example 2 (see Table 4).

TABLE 6

| | | Added | | | Residual |
|---|---|---|---|---|---|
| | VVH | H₂/HC | Temperature | Pressure | Coke |
| Reactor | h⁻¹ | NL/L | ° C. | MPa | % |
| R1 | 3 | 5 | 130 | 2.5 | 2.9 |
| R2 | 3 | 5 | 187 | 2.5 | 2.8 |

Thus, the method according to the invention of two steps that are carried out at two different temperatures (with T2 being higher than T1) makes it possible to produce a gasoline with low contents of diolefins and light sulfides while extending the service life of the catalyst.

1. Method for reducing the content of sulfide-type compounds of formula R1-S—R2, with R1 and R2 selected from among the methyl (CH₃) and ethyl (C₂H₅) radicals, of a gasoline that contains diolefins, monoolefins, and sulfur, in which:
A) In a first reactor, the gasoline is brought into contact with hydrogen and a catalyst A that comprises at least one metal of group VIb and at least one non-noble metal of group VIII that are deposited on a substrate, with step A being carried out at a temperature in the reactor of between 60° C. and 150° C. with an hourly volumetric flow rate (VVH) of between 1 h⁻¹ and
10 h⁻¹, a pressure of between 0.5 and 5 MPa, and with a volumetric ratio of added H₂/gasoline feedstock of between 1 to 40 normal liters of hydrogen per liter of gasoline (vol/vol), in such a way as to produce an effluent at a temperature T1 of between 60° C. and 150° C. and having a lower diolefin content than that of the starting gasoline;
B) The effluent that is obtained from the first reactor is heated in a heating device at a temperature T2 with a temperature difference ΔT (T2-T1) of between 10° C. and 100° C.;
C) In a second reactor, the effluent that is heated at the temperature T2 is brought into contact with a catalyst C that comprises at least one metal of group VIb and at least one non-noble metal of group VIII that are deposited on a substrate and optionally with hydrogen, and in which:
Step C is carried out with an hourly volumetric flow rate (VVH) of between 1 h⁻¹ and 10 h⁻¹, a pressure of between 0.5 and 5 MPa, with a volumetric ratio of added H₂/gasoline feedstock of between 0 to 40 normal liters of hydrogen per liter of gasoline (vol/vol), in such a way as to produce an effluent from the second reactor that has a content of sulfide-type compounds of formula R1-S—R2, with R1 and R2 selected from among the methyl (CH3) and ethyl (C2H5) radicals, lower than that of the starting gasoline.

2. Method according to claim 1, in which the temperature difference ΔT (T2-T1) is between 20° C. and 80° C.

3. Method according to claim 1 that comprises a step D in which the effluent that is obtained from step C is separated into a light gasoline fraction and a heavy gasoline fraction that contains hydrocarbons having six and more than six carbon atoms.

4. Method according to claim 3, in which steps C and D are carried out in a catalytic distillation column that comprises a catalytic cross-section that contains the catalyst C.

5. Method according to claim 3, in which the heavy gasoline fraction that is obtained from step D is treated in a hydrodesulfurization unit in the presence of hydrogen.

6. Method according to claim 1, in which the catalysts A and C are sulfurized.

7. Method according to claim 6, in which the sulfurization rate of the metals that constitute said catalysts is at least equal to 60%.

8. Method according to claim 1, in which the catalyst A or the catalyst C comprises:
A metal oxide content of group VIb of between 4 and 20% by weight in relation to the total weight of the catalyst,
A metal oxide content of group VIII of between 4 to 15% by weight in relation to the total weight of the catalyst,
A sulfurization rate of the metals that constitute said catalyst that is at least equal to 60%,
A molar ratio between the non-noble metal of group VIII and the metal of group VIb of between 0.6 and 3 mol/mol,
A density of metal of group VIb per unit of surface area of the catalyst that is strictly less than 10⁻³ gram of oxides of the metal of group VIb per m² of catalyst;
A specific surface area of the catalyst of between 30 and 300 m²/g.

9. Method according to claim 1, wherein the metal of group VIb of the catalysts A and C is selected from among molybdenum and tungsten, preferably molybdenum.

10. Method according to claim 1, in which the metal of group VIII of the catalysts A and C is selected from among nickel, cobalt, and iron, preferably nickel.

11. Method according to claim 1, in which the metal of group VIII of the catalysts A and C is nickel, and the metal of group VIb of the catalysts A and C is molybdenum.

12. Method according to claim 1, in which the catalysts A and C are identical compositions.

13. Method according to claim 1, in which the gasoline is obtained from catalytic cracking or thermal cracking, a coking method, a visbreaking method, or a pyrolysis method.
